(19) United States
(12) Patent Application Publication
(10) Pub. No.: US 2026/0092803 A1
(43) Pub. Date: Apr. 2, 2026

(54) OPERATING METHOD OF AN INTERFACE SENSOR AND INTERFACE SENSOR

(71) Applicant: Endress+Hauser Conducta GmbH+Co. KG, Gerlingen (DE)

(72) Inventors: Benjamin Bertsch, Gerlingen (DE); Lukas Graf, Mutlangen (DE); Benjamin Gross, Pforzheim (DE)

(21) Appl. No.: 19/344,748

(22) Filed: Sep. 30, 2025

(30) Foreign Application Priority Data
Sep. 30, 2024 (DE) 10 2024 128 268.1

(51) Int. Cl. G01F 23/296

(52) U.S. Cl. CPC G01F 23/296

(57) ABSTRACT

The present disclosure relates to an operating method of an interface sensor, comprising steps of: arranging the interface sensor in a container full of a measurement medium so that the interface sensor is in contact with the measurement medium, and recording a measured value curve with measured values using the interface sensor. The method also includes evaluating the measured value curve using a control unit, comprising steps of: determining a layer boundary, determining a first sedimentation parameter, determining a second sedimentation parameter, determining a sedimentation indicator on the basis of a relationship between the first sedimentation parameter and the second sedimentation parameter, and outputting of the sedimentation indicator using the control unit.

### CROSS-REFERENCE TO RELATED APPLICATION

The present application is related to and claims the priority benefit of foreign patent application no. DE 102024128 268.1, filed on September 30, 2024, the entire contents of which are incorporated herein by reference.

### TECHNICAL FIELD

The present disclosure relates to an operating method of an interface sensor, an interface sensor, a sedimentation plant and an automatic control method of a sedimentation plant.

### BACKGROUND

Interface sensors that emit acoustic signals or optical signals, for example, are used to detect interfaces in containers full of liquids. For this purpose, these sensors are immersed in the liquid. These acoustic signals for example propagate in the liquid and are reflected back to the sensor once they impinge upon an interface in the liquid or in the container consisting for example of solid particles.

Such interface sensors are used in particular in process manufacturing in so-called sedimentation or precipitation processes. Here, suspended solids are separated from a liquid process medium. The solids of a mixed sample sink to the bottom of a tank where they are extracted by suction. The liquid medium in the upper tank region is also extracted by suction or passed on via a type of overflow so as to be as free from suspended solids as possible. The settling velocity of the solid particles depends on several factors and is a determining factor for the capacity of the entire production process. To accelerate sedimentation, sedimentation agents or flocculants are added to the medium.

In order to achieve the best sedimentation, in many cases the sedimentation agents are overdispensed, which is associated with high costs.

### SUMMARY

It is therefore one object of the present disclosure to propose a method for operating an interface sensor which makes it possible to reliably and cost-effectively monitor a sedimentation process.

This object is achieved according to the present disclosure by an operating method of an interface sensor according to the present disclosure.

The operating method according to the present disclosure comprises: arranging an interface sensor in a container filled with a measurement medium so that the interface sensor is in contact with the measurement medium, recording by means of the interface sensor a measured value curve with measured values, evaluating the measured value curve by means of the control unit, involving: determining a layer boundary, determining a first sedimentation parameter, determining a second sedimentation parameter, determining a sedimentation indicator on the basis of a relationship between the first sedimentation parameter and the second sedimentation parameter, and outputting the sedimentation indicator by means of the control unit.

The operating method according to the present disclosure makes it possible for a sedimentation process to be reliably and cost-effectively monitored. In particular, whether or not optimum sedimentation is taking place is detected at an early stage. It also makes it possible to detect suspended solids near the surface at an early stage. This makes it possible to reliably monitor the entire depth of the sedimentation tank. This in turn makes possible a cost-effective and environmentally friendly closed-loop control of the sedimentation agent during the sedimentation process.

According to one embodiment of the present disclosure, during the evaluation process, a measurement function is determined by curve-fitting the measured value curve.

According to one embodiment of the present disclosure, at least one derivative of the measurement function is used when determining the layer boundary.

According to a further embodiment of the present disclosure, at least a first maximum of the measurement function and a distance are used when determining the layer boundary.

According to one embodiment of the present disclosure, at least a first inflection point of the measurement function is used when determining the layer boundary.

According to one embodiment of the present disclosure, in the determination of the first sedimentation parameter, a first area or first projection length formed on the basis of the measured value curve is determined, wherein, in the determination of the second sedimentation parameter, a second area or second projection length formed on the basis of the measured value curve is determined.

According to one embodiment of the present disclosure, in the determination of the first sedimentation parameter, a first inflection point projection or first maximum projection formed on the basis of the measurement function is determined, wherein, in the determination of the second sedimentation parameter, a second inflection point projection or second maximum projection formed on the basis of the measurement function is determined.

According to one embodiment of the present disclosure, measured values that fall within an exclusion range are disregarded in the evaluation of the measured value curve.

According to one embodiment of the present disclosure, a warning message is issued when measured values fall within the exclusion range.

The aforementioned object is also achieved by a sedimentation plant according to the present disclosure.

The sedimentation plant according to the present disclosure comprises: an interface sensor, a container for receiving a measurement medium, wherein the interface sensor is arranged relative to the container such that the interface sensor is suitable for being immersed in the measurement medium, a precipitant inlet for introducing a precipitant into the measurement medium, wherein the precipitant inlet has an inlet valve that is connected to the control unit. The aforementioned object is also achieved by a method for using closed-loop control to control a sedimentation plant. The closed-loop control method according to the present disclosure comprises: providing a sedimentation plant according to the present disclosure, operating the interface sensor according to the operating method according to the present disclosure, using open-loop control to control the inlet valve by means of the control unit on the basis of the sedimentation indicator and of a threshold value in order to control the introduction of the precipitant into the measurement medium using closed-loop control.

### BRIEF DESCRIPTION OF THE DRAWINGS

The present disclosure is explained in more detail on the basis of the following description of the figures in which:

FIG. 1 shows a schematic representation of a sedimentation plant according to the present disclosure with an interface sensor according to the present disclosure,

FIG. 2 shows a schematic representation of a measured value curve of a sedimentation process with optimal sedimentation behavior recorded by the interface sensor,

FIG. 3 shows a schematic representation of a measurement function determined by curve-fitting the measured value curve from FIG. 1.

FIG. 4 shows a schematic representation of a measured value curve of a sedimentation process with poor sedimentation behavior recorded by the interface sensor,

FIG. 5 shows a schematic representation of a measured value curve of a sedimentation process with extremely poor sedimentation behavior recorded by the interface sensor.

### DETAILED DESCRIPTION

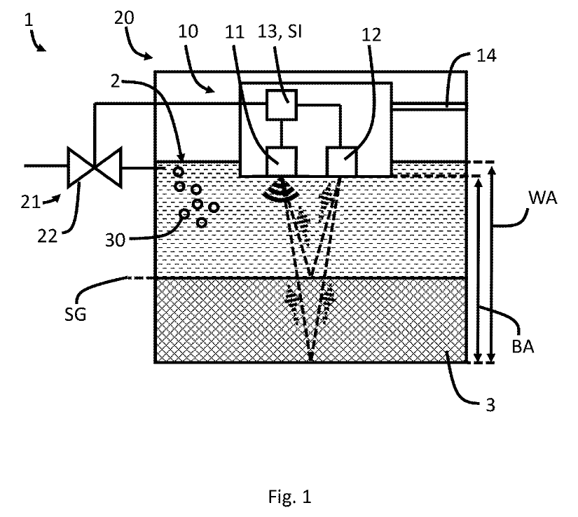

FIG. 1 shows a sedimentation plant 1 according to the present disclosure with an interface sensor 10 according to the present disclosure. The sedimentation plant 1 is used, for example, in a wastewater treatment plant, a drinking water treatment plant or a metal ore extraction plant.

The sedimentation plant 1 comprises a container 20 for receiving a measurement medium 2. The container 20 is, for example, a secondary settlement tank or what is known as a “sequencing batch reactor”, or another vessel. For example, the container 20 is open at the top. The container 20 is suitable for a sediment layer 3 to be deposited on the floor or base thereof by the measurement medium 2. The sediment layer 3 is part of the measurement medium 2 and is produced, for example, by heavy particles in the measurement medium 2 sinking, i.e. a decanting of the measurement medium 2. This sinking can be accelerated by a chemical precipitation reaction of the measurement medium 2 with a sedimentation agent or precipitant 30.

The sedimentation plant 1 comprises an inlet 21 for the medium to be clarified, an overflow for clear medium and an outlet for the sediment. The inlet 21 can be integrated into the container 20, as shown in FIG. 1, or, for example, can also be arranged above or in the container 20, for example without contacting the container due to the use of a hose or the like to supply the precipitant 30 to the container 20. The precipitant is injected into the inlet for the medium that is to be clarified via a regulatable device, such as a pump or valve, or is added directly to the container. The inlet 21 comprises an inlet valve 22 for regulating the amount of precipitant 30 added to the measurement medium 2.

The interface sensor 10 is preferably an acoustic sensor. However, it is also possible to use a different sensor that makes it possible to detect particles in the measurement medium 2. For example, the interface sensor 10 is an optical sensor.

The interface sensor 10 is preferably fixedly attached to the container 20 by a holder 14 (see FIG. 1), for example horizontally eccentrically to the container axis. However, it is also possible for the interface sensor 10 to be movable relative to the container 20 so that the interface sensor 10 can be immersed, for example as far as the bottom of the container 20. Immersing the interface sensor 10 in the container 20 is particularly advantageous if the interface sensor 10 is an optical sensor. Fixedly attaching it to the container 20 is particularly advantageous if the interface sensor 10 is an acoustic sensor.

In the following, an interface sensor 10, which is designed as an acoustic sensor, is described first.

The interface sensor 10 comprises a sound emitter 11, a sound detector 12, and a control unit 13. The sound emitter 11 and sound detector 12 can also be embodied in a common unit, i.e. as transceivers 11, 12. In this event, the transceiver 11, 12 therefore functions on the one hand as a sound emitter and on the other hand as a sound detector. If the sound emitter 11 or the sound detector 12 is mentioned in the following, the transceiver is always also meant at the same time. Of course, all embodiments can also be realized with a transceiver.

The sound emitter 11 and sound detector 12 are connected to the control unit 13. Likewise, the inlet valve 22 is connected to the control unit 13 in order to be controlled by the control unit 13. The interface sensor 10 is fixedly arranged relative to the container bottom. However, the interface sensor 10 can also be movable relative to the container 20, since the interface sensor 10 is suitable for determining the bottom distance BA and the water level distance WA by itself.

According to a further embodiment (not shown), the interface sensor 10 can also be arranged to be floating or freely immersed in the measurement medium 2.

The sound emitter 11 is suitable for generating at least one sound signal. The sound detector 12 is suitable for detecting at least one signal response initiated by the first sound signal.

The control unit 13 is suitable for determining a measured value curve MK with measured values Mi from the signal response.

The control unit 13 may also be equipped with a communication module, for example a wireless or wired communication module. The control unit 13 is thus suitable for outputting information to a user or to the inlet valve 22.

The operating method of the interface sensor 10 is discussed in detail below.

The operating method involves arranging the interface sensor 10 in the container 20, which is filled with the measurement medium 2, so that the interface sensor 10 is in contact with the measurement medium 2. As shown in FIG. 1, the interface sensor 10 is preferably partially immersed in the measurement medium 2.

A measured value curve MK with measured values Mi (where I = {1, 2, 3, …}) is then recorded by the interface sensor 10. For this purpose, a sound signal is emitted by the sound emitter 11, which is in turn detected by the sound detector 12. The control unit 13 determines a measured value curve MK from the detected sound signal. The measured value curve MK is composed of measured values Mi, which represent an amplitude of the detected sound signal, for example, i.e. the echo amplitude E, on the ordinate and a depth D of the detected sound signal, for example, on the abscissa. This thus makes it possible to see how many particles are in the measurement medium 2 and at what depth. The depth D0 is the position of the sound emitter 11 and sound detector 12 in the measurement medium 2.

Next, the measured value curve MK is evaluated by the control unit 13. This evaluation process in particular involves determining a layer boundary SG, determining a first sedimentation parameter S1 on the basis of measured values Mi above the layer boundary SG and determining a second sedimentation parameter S2 on the basis of measured values Mi below the layer boundary SG.

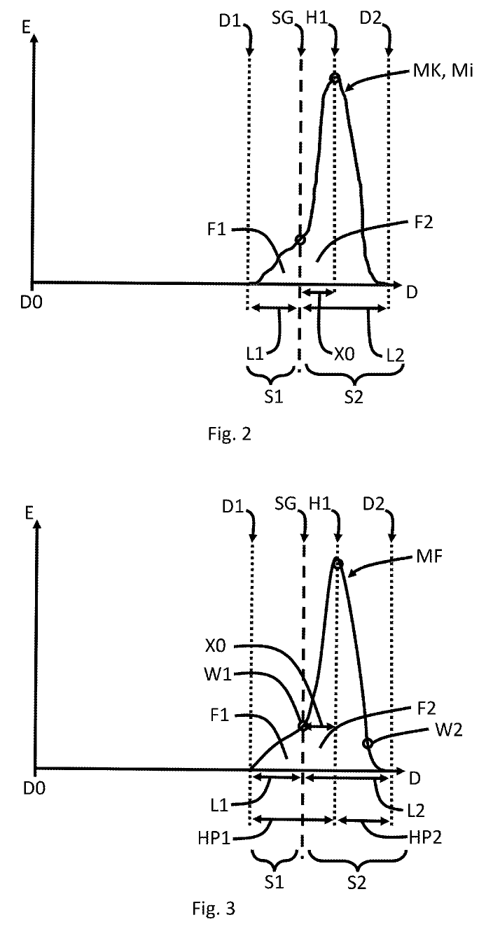

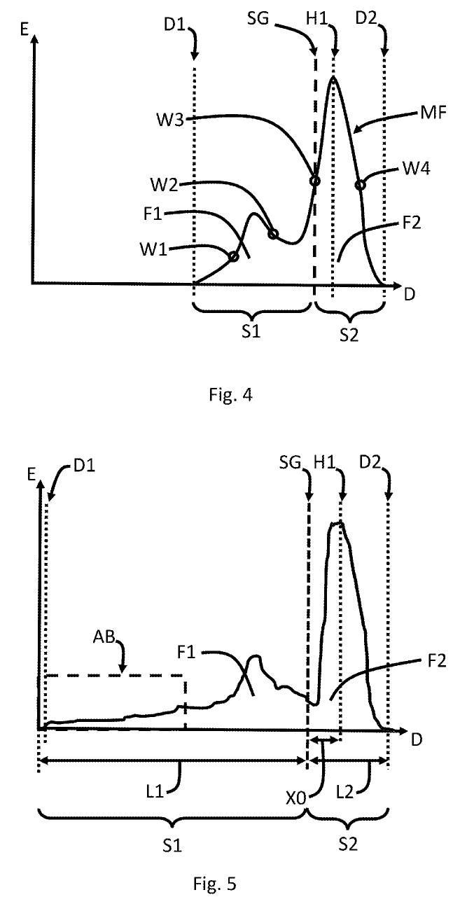

The measured value curve MK is evaluated either directly using the measured values Mi of the measured value curve MK (see FIG. 2 and FIG. 5), or using a measurement function MF, which represents a fitted curve for the measured value curve MK, i.e. a mathematically approximate representation of the measured value curve MK (see FIG. 3 and FIG. 4).

The evaluation of the measured value curve MK without curve-fitting is described first, as shown in FIG. 2.

In the determination of the layer boundary SG, a first maximum H1 of the measured value curve MK, i.e. the measured value Mi with the highest echo amplitude E, is first determined. The depth of this first maximum H1 is then noted. Next, the layer boundary SG is set at a depth which is above the depth of the first maximum H1 by the distance X0. The layer boundary SG is therefore further away from the tank floor than the first maximum H1. The distance X0 is stored in the control unit 13 and depends, for example, on the particles expected in the measurement medium 2. The distance X0 is, for example, based on empirical values. For example, the distance X0 is a few decimeters.

In the determination of the first sedimentation parameter S1, a region of the measured value curve MK above the layer boundary SG, i.e. further away from the tank floor than the layer boundary SG, is taken into consideration.

For example, a first area F1 under the measured value curve MK between a first depth D1 and the layer boundary SG is determined. The first depth D1 is defined by the highest measured value Mi, i.e. the measured value Mi which is furthest away from the tank floor (see FIG. 2). In the determination of the first area F1, the echo amplitudes of the measured values Mi are added together, for example, and multiplied by the difference between the depth of the layer boundary SG and the first depth D1. The first area F1 thus corresponds to the first sedimentation parameter S1.

As an alternative, in the determination of the first sedimentation parameter S1, it is also possible to use only the difference between the depth of the layer boundary SG and the first depth D1, i.e. a first projection length L1 of the measured value curve MK on the abscissa, as the first sedimentation parameter S1 (see e.g. FIG. 2).

In the determination of the second sedimentation parameter S2, a region of the measured value curve MK below the layer boundary SG, i.e. closer to the tank floor than the layer boundary SG, is taken into consideration.

For example, a second area F2 below the measured value curve MK between the layer boundary SG and a second depth D2 is determined. The second depth D2 is defined by the lowest measured value Mi, i.e. the measured value Mi which is closest to the floor of the tank (see FIG. 2). For this purpose, the echo amplitudes of the measured values Mi are added together, for example, and multiplied by the difference between the depth of the layer boundary SG and the second depth D2. The second area F2 thus corresponds to the second sedimentation parameter S2.

Alternatively, in the determination of the second sedimentation parameter S2, it is also possible to use only the difference between the depth of the layer boundary SG and the second depth D2, i.e. a second projection length L2 of the measured value curve MK on the abscissa, as the second sedimentation parameter S2 (see e.g. FIG. 2).

The following describes the evaluation of the measured value curve MK with curve-fitting, as shown for example in FIG. 3.

In the evaluation of the measured value curve MK, it is preferable to first determine a measurement function MF by curve-fitting the measured value curve MK. Curve-fitting is carried out, for example, by a polynomial fit, by the method of least squares or by spline interpolation. Determining and using a measurement function MF has the advantage that many evaluation steps can thus be implemented mathematically simply. FIG. 3 shows a schematic curve fit of the measured value curve MK from FIG. 2. FIG. 4 shows another measurement function MF, which was created using a schematically shown curve fit of a measured value curve MK.

In the determination of the layer boundary SG, at least one derivative of the measurement function MF is preferably used.

For example, in the determination of the layer boundary SG, the first derivative of the measurement function MF is used to determine at least a first maximum H1 and a distance X0 (see FIG. 2). This means that the first maximum H1 is first determined by deriving the measurement function MF and the layer boundary SG is then set at a depth D which is above the depth of the first maximum H1 by the distance X0. The layer boundary SG is therefore further away from the tank floor than the first maximum H1. The distance X0 is stored in the control unit 13 and depends, for example, on the particles expected in the measurement medium 2. The distance X0 is, for example, based on empirical values. For example, the distance X0 is a few decimeters.

As an alternative to the first derivative of the measurement function MF, for example, in the determination of the layer boundary SG, the second derivative of the measurement function MF is used to determine the layer boundary SG. At least a first inflection point W1 of the measurement function MF is determined here (see FIG. 3). If there are two inflection points, the inflection point which is above the first maximum H1, i.e. further away from the tank floor than the first maximum H1, is used as the layer boundary SG.

If the measurement function MF has more than two inflection points W1, W2, W3, W4, as shown for example in the measurement function MF shown in FIG. 4, the layer boundary SG at the third inflection point W3 is preferably selected. However, it is also possible to choose an alternative point for the layer boundary SG, for example between the inflection point which is above the first maximum H1, i.e. further away from the tank floor than the first maximum H1, and the inflection point which is even higher. Further alternatives when choosing the layer boundary SG are to choose the layer boundary SG between the first inflection point W1 and the fourth inflection point W4. In other words, it is up to the user to choose the layer boundary SG. However, the first example described above is a very reliable and robust procedure for selecting the layer boundary SG.

In the determination of the first sedimentation parameter S1, a region of the measurement function MF above the layer boundary SG, i.e. further away from the tank floor than the layer boundary SG, is taken into consideration.

For example, a first area F1 below the measurement function MF between a first depth D1 and the layer boundary SG is determined. The first depth D1 is defined by a first point at which the measurement function MF intersects the abscissa (see FIG. 3). In the determination of the first area F1, an integral is formed over the measurement function MF from the first depth D1 to the layer boundary SG. The first area F1 thus corresponds to the first sedimentation parameter S1.

As an alternative, for example, a first area F1 below the measurement function MF between a first reference value of the measurement function and the layer boundary SG is determined. For example, the first reference value is at 5% of the measurement function MF relative to the maximum amplitude of the measurement function. That is to say, a point at which the measurement function MF intersects a straight line which intersects the measurement function MF at 5% relative to the maximum amplitude of the measurement function. Since this straight line will have at least two points of intersection with the measurement function, the first reference value is the left-hand one, i.e. a position that is close to the surface.

As an alternative, in the determination of the first sedimentation parameter S1, it is possible to use only the difference between the depth of the layer boundary SG and the first depth D1, i.e. a first projection length L1 of the measurement function MF on the abscissa, as the first sedimentation parameter S1 (see FIG. 3).

As a further alternative, in the determination of the first sedimentation parameter S1, it is also possible to use only the difference between the depth of the first maximum H1 and the first depth D1, i.e. a first maximum projection HP1 of the measurement function MF on the abscissa, as the first sedimentation parameter S1 (see FIG. 3).

In the determination of the second sedimentation parameter S2, a region of the measurement function MF below the layer boundary SG, i.e. closer to the tank floor than the layer boundary SG, is taken into consideration.

For example, a second area F2 below the measurement function MF between the layer boundary SG and the second depth D2 is determined. The second depth D2 is defined by a first point of intersection between the measurement function MF and the abscissa (see FIG. 3). When determining the first area F1, an integral is formed over the measurement function MF from the layer boundary SG to the first depth D1. The second area F2 thus corresponds to the second sedimentation parameter S2.

As an alternative, for example, a second area F2 below the measurement function MF between the layer boundary SG and a second reference value of the measurement function is determined. The second reference value is, for example, 5% of the measurement function MF relative to the maximum amplitude of the measurement function. That is to say, a point at which the measurement function MF intersects a straight line which intersects the measurement function MF at 5% relative to the maximum amplitude of the measurement function. Since this straight line has at least two points of intersection with the measurement function, the second reference value is the intersection point on the right in the diagram, i.e. is at a position that is close to the tank floor.

As an alternative, in the determination of the second sedimentation parameter S2, it is also possible to use only the difference between the depth of the layer boundary SG and the second depth D2, i.e. a second projection length L2 of the measurement function MF on the abscissa, as the second sedimentation parameter S2 (see FIG. 3).

As a further alternative, in the determination of the second sedimentation parameter S2, it is also possible to use only the difference between the depth of the first maximum H1 and the second depth D2, i.e. a second maximum projection HP2 of the measurement function MF on the abscissa, as the second sedimentation parameter S2 (see FIG. 3).

In the evaluation of the measured value curve MK with or without curve-fitting, at least one exclusion range AB can optionally also be defined, with the measured values Mi or regions of the measurement function MF therein not being taken into account. This is shown in FIG. 5. The advantage of this exclusion range AB is that, for example, interference signals caused by obstructions in the tank, such as fixtures or other sensors, are ignored.

Preferably, a warning message is issued if measured values Mi fall within the exclusion range AB. The warning message is issued, for example, via a display or loudspeaker or the communication module of the control unit 13. The warning message is issued, for example, during or after the evaluation of the measured value curve.

According to the variants described above whereby the measured value curve MK is evaluated by the control unit 13, a sedimentation indicator SI is determined on the basis of a ratio between the first sedimentation parameter S1 and the second sedimentation parameter S2.

The sedimentation indicator SI is determined, for example, by the following first formula: SI = S1/(S1+S2). In this case, sedimentation of the particles in the measurement medium 2 will be optimal, the smaller the sedimentation indicator SIs. SI = 0 would therefore be perfect sedimentation.

Of course, the sedimentation indicator SI can also be determined, for example, by the following second formula: SI = S2/(S1+S2). In this case, sedimentation of the particles in the measurement medium 2 will be optimal, the larger the sedimentation indicator SI. SI = 1 would therefore be perfect sedimentation.

Of course, it is possible to supplement the formulas described above with further mathematical objects in such a way that the sedimentation indicator SI can be used for regulation directly or indirectly with the aid of a closed-loop control transfer function. For example, it can also be given as a percentage. The aforementioned formulas would then be multiplied by 100, for example. Alternatively, addition/subtraction with a fixed value would of course also be possible in order to shift the sedimentation indicator SI into the positive/negative number range. This then enables, for example, “closed-loop control at zero”, i.e. at a specific target value which is equal to zero as a result of the offset. Alternatively, it is also conceivable for the first sedimentation parameter S1 or the second sedimentation parameter S2 to be multiplied by a factor in order to bring about a particular weighting.

In other words, depending on the variants described above for determining the first sedimentation parameter S1 or the second sedimentation parameter S2, the first area F1 and the second area F2 are compared, or the first projection length L1 and the second projection length L2 are compared, or the first maximum projection HP1 and the second maximum projection HP2 are compared.

The sedimentation indicator SI is then output by the control unit 13. This is done, for example, via a display or the communication module of the control unit 13.

As mentioned above, it is also possible to apply the method to interface sensors 10 which are not acoustic sensors. For example, an optical sensor or a density measurement sensor that uses vibronics could also be used as the interface sensor 10. However, when these sensors are used, recording the measured value curve MK will involve gradual immersion of the interface sensor 10 in the measurement medium 2 from the surface to the floor of the container 20. The disadvantage of this gradual immersion is, however, that the interface sensor 10 may be exposed to particles and could become damaged or contaminated. The advantage of an acoustic interface sensor 10 is therefore that it is arranged close to the surface of the measurement medium 2, which usually corresponds to a region in which very few and/or only very small particles are arranged, thereby avoiding damage to the interface sensor 10.

A method for controlling a sedimentation plant 1 using closed-loop control method is described below.

First, a sedimentation plant 1 as described above is provided. This means that the sedimentation plant 1 is ready for operation, i.e. the container 20 is filled with measurement medium 2 and an interface sensor 10 is in contact with the measurement medium 2.

The interface sensor 10 is then operated according to one of the operating methods described above.

Next, the inlet valve 22 is controlled by the control unit 13 on the basis of the sedimentation indicator SI and a threshold value so that the introduction of the precipitant 30 into the measurement medium 2 is regulated. In particular, the inlet valve 22 will be opened if the sedimentation indicator SI reports less optimal sedimentation. Using the first formula mentioned above, this would be the case if the sedimentation indicator SI were, for example, greater than the threshold value of 0.5. Of course, another threshold value that is specified by the user and is dependent, for example, on the particles in the measurement medium 2 can also be set.

One advantage of using the first projection length L1 and the second projection length L2 is that it is in particular possible to see whether there are particles near the surface of the measurement medium 2. In this case, for example, a separate warning message can be issued to the user.

1. An operating method of an interface sensor, comprising steps of:
arranging an interface sensor in a container full of a measurement medium so that the interface sensor is in contact with the measurement medium,
recording a measured value curve with measured values using the interface sensor,
evaluating the measured value curve using the control unit, comprising steps of:
determining a layer boundary,
determining a first sedimentation parameter,
determining a second sedimentation parameter,
determining a sedimentation indicator on the basis of a relationship between the first sedimentation parameter and the second sedimentation parameter,
outputting the sedimentation indicator using the control unit.

2. The operating method according to claim 1, wherein, during the evaluation process, a measurement function is determined by curve-fitting the measured value curve.

3. The operating method according to claim 2, wherein at least one derivative of the measurement function is used in the determination of the layer boundary.

4. The operating method according to claim 3, wherein at least a first maximum of the measurement function and a distance are used in the determination of the layer boundary.

5. The operating method according to claim 3, wherein at least a first inflection point of the measurement function is used in the determination of the layer boundary.

6. The operating method according to claim 1, wherein, in the determination of the first sedimentation parameter, a first area or first projection length formed on the basis of the measured value curve is determined,
wherein, in the determination of the second sedimentation parameter, a second area or second projection length formed on the basis of the measured value curve is determined.

7. The operating method according to claim 2, wherein, in the determination of the first sedimentation parameter, a first inflection point projection or first maximum projection formed on the basis of the measurement function is determined,
wherein, in the determination of the second sedimentation parameter, a second inflection point projection or second maximum projection formed on the basis of the measurement function is determined.

8. The operating method according to claim 1, wherein, in the evaluation of the measured value curve, measured values which fall within an exclusion range are disregarded.

9. The operating method according to claim 8, wherein a warning message is issued when measured values fall within the exclusion range.

10. A sedimentation plant, comprising:
an interface sensor,
a container for receiving a measurement medium, wherein the interface sensor is arranged relative to the container such that the interface sensor is suitable for being immersed in the measurement medium,
a precipitant inlet for introducing a precipitant into the measurement medium, wherein the precipitant inlet has an inlet valve connected to a control unit.

11. A closed-loop control method of a sedimentation plant, comprising:
wherein the sedimentation plant includes:
an interface sensor,
a container for receiving a measurement medium, wherein the interface sensor is
arranged relative to the container such that the interface sensor is suitable for being
immersed in the measurement medium,
a precipitant inlet for introducing a precipitant into the measurement medium, wherein
the precipitant inlet has an inlet valve connected to a control unit,
the method including:
operating the interface sensor according to the method of claim 1, and
controlling the inlet valve by means of the control unit on the basis of the sedimentation
indicator and a threshold value so that the introduction of the precipitant into the measurement
medium is regulated.
